(19) United States
(12) Patent Application Publication
(10) Pub. No.: US 2022/0343352 A1
(43) Pub. Date: Oct. 27, 2022

(54) ONLINE FEEDBACK NETWORK FOR IDENTIFYING AND REWARDING DEMOGRAPHIC PROFILED FEEDBACK SUBMITTERS

(71) Applicant: Laurent Delly, New York, NY (US)

(72) Inventors: Laurent Delly, New York, NY (US); Price-Mars Delly, New York, NY (US)

(21) Appl. No.: 17/238,980

(22) Filed: Apr. 23, 2021

(51) Int. Cl. G06Q 30/02; G06F 16/248

(52) U.S. Cl. CPC G06Q 30/0203; G06Q 30/0201; G06Q 30/0217; G06F 16/248

(57) ABSTRACT

A system is provided for generating an agility index associated with product survey results. The system comprises a processor, a memory, and an application stored in the memory that when executed on the processor receives, aggregates and stores a first survey feedback data received in a first survey. The system also activates a feature to benchmark the first survey data and edits and updates survey questions to produce a second questionnaire. The system also distributes the second questionnaire in a second survey and compares a second survey feedback received in the second survey to the benchmarked first survey data to determine a strategic agility index. The comparison comprises determining percentage changes in surveyed data points from the first survey to the second survey. The second survey is sent to one of the same and similar feedback submitters that submitted the first survey feedback data.

### CROSS REFERENCE TO RELATED APPLICATION

The present non-provisional patent application is a continuation-in-part of U.S. patent application Ser. No. 16/854,167 filed Apr. 21, 2020, the contents of which are incorporated herein in their entirety.

### FIELD OF THE INVENTION

The present disclosure is in the field of conducting customer surveys. More particularly, the present disclosure matches demographic groups of customers with demographic groups specified by vendors to build survey respondent groups that provide valuable feedback and receive incentives and rewards to continue providing feedback.

### BACKGROUND

Commercial feedback processes currently available focus on open-ended surveys filled with general questions that provide limited insight on processes of learning how customers interact with products and services they buy. Such open-ended surveys do not capture the social experience of a survey respondent.

These generalized surveys do not allow for personalized feedback in an online community marketplace format as means to improve a product or service. They do not offer custom rewards and incentives that may encourage the submission of high-quality feedback in either a virtual (online) or live setting. Generalized surveys do not encourage respondents to provide additional feedback in future surveys.

### BRIEF DESCRIPTION OF THE FIGURE

FIG. 1 is a block diagram of a system of feedback through an online community format according to an embodiment of the present disclosure.

FIG. 2 is a flow chart of a method of feedback through an online community format according to an embodiment of the present disclosure.

### DETAILED DESCRIPTION

Systems and methods described herein enable improvement of commercial goods and services by providing a system for generating sustainable feedback through an online community format in exchange for incentives to survey respondents. An online platform of a community feedback marketplace provided herein generates feedback that captures the social experiences of the respondents.

After initially surveying large general populations of buyers, systems employ quality controls to identify subsets of survey respondents that consistently provide meaningful and valuable feedback, as well as respondents whose demographic profiles match the profiles specified by product vendors generating the surveys. Systems provided herein may thereafter direct further and more detailed surveys to respondents in the identified subsets with the objective of receiving even more meaningful feedback. Those respondents, who may be referred to as “feedback submitters”, are encouraged to continue providing deeper and more detailed feedback.

Survey feedback and other data is shared among respondents within groups to create communities of online feedback submitters. Social media is used to link respondents and encourage feedback submitters to communicate with each other and foster collaboration of ideas and suggestions. Vendors whose products and services are the subject of surveying may also be part of the communities and communicate directly with feedback submitters about specific remarks made by submitters.

Using systems and methods provided herein, such vendors launch projects requesting detailed and meaningful feedback. The vendors request the system to create project demographic profiles that may align with demographic profiles of customers who provide desired feedback. The system compares project demographic profiles with demographic profiles of feedback submitters to find matches that yield potentially valuable sources of feedback.

The vendors, who may be referred to as “feedback receivers”, may participate in the communities described above that use social network to communicate and share ideas. The feedback receivers also sponsor the sending of incentives and rewards to feedback providers who consistently generate valuable survey response material to feedback receivers, material the receivers may use in improving their products and services.

When a feedback receiver, for example a vendor of consumer products, receives an item of feedback that the feedback receiver considers favorable, the receiver may print or otherwise copy portions of the feedback to stickers or placards. Such media may then be attached or posted to products or displays in public places that prospective customers may view. The quality control measures provided herein are used in determining the appropriate areas of feedback to use in such postings.

Customized rewards and incentives from feedback receivers comprising at least entrepreneurs, businesses, and organizations are given to feedback submitters in return for the delivery by submitters of personalized feedback. The feedback may be used by feedback receivers toward improving a product or service at various phases of the product or service lifecycle. Feedback receivers hence are given means to identify items of information that may be vital for improvement of the goods and services.

Feedback receivers are also provided means to effectively pinpoint flaws and opportunities through a mutually beneficial, reward-based process. Systems and methods utilize skills, knowledge, and personal experience of feedback submitters as bases for delivering unique and tailored feedback. Such feedback may improve the business value proposition of a service or product offered in the marketplace.

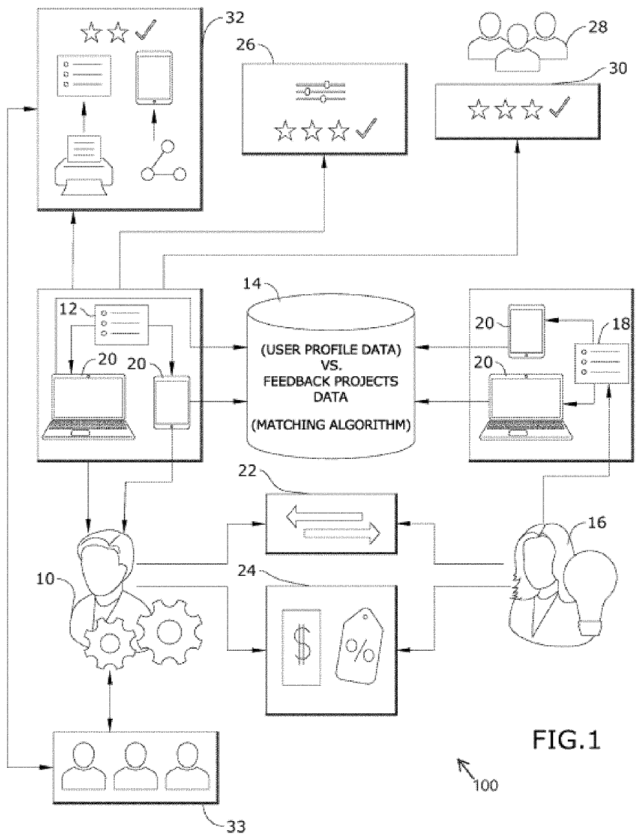

Turning to the figures, FIG. 1 is a block diagram of a feedback system and method through an online community format in accordance with an embodiment of the present disclosure. FIG. 1 depicts components and interactions of a system 100 provided herein.

The components of the system 100 comprise feedback receivers 10, feedback response data 12, an online feedback community network 14, feedback submitters 16, profile information 18, and at least one computer 20. The components also comprise incentives and rewards 24, quality control measures 26, business entities 28, feedback stickers 30, shared feedback 32, and other users 33.

For brevity purposes, the feedback receivers 10, the feedback response data 12, the online feedback community network 14, and the feedback submitters 16 may be referred to hereafter as the receivers 10, the data 12, the network 14, and the submitters 16. While not shown, at least one application may execute on the computer 20 and in the network 14 that provide systems and methods described herein.

The feedback submitters 16, usually customers, and the feedback receivers 10, usually vendors, are connected to the online feedback community network 14. The network 14 may be an Internet-based platform and may execute at least on the computer 20. A matching algorithm may execute on the computer 20 and be adapted to use similarities in data sets including feedback response data 12 and machine intelligence learning.

A feedback submitter 16, based on his/her use of products sold by the feedback receiver 10, submits feedback response data 12 via the network 14. This data 12 may comprise written responses, live voting data, and voice messages.

Incentives and rewards 24 may be released by the feedback receiver 10 once the feedback response data 12 has been approved. Such incentives and rewards 24 may be given to the feedback submitter 16 via online shop, mail, or live and in person, electronically or physically. Feedback response data 12 is exportable to other feedback submitters 16 on the network 14 as shared feedback 32.

Shared feedback 32 is subject to quality control measures 26 that may be adapted to define how, what portion, and to whom the data 12 is exported and shared. The data 12 may be shared with business entities 28 as well as other peers 33 affiliated with the associated feedback receiver 10.

The business entities 28, if registered users of the network 14, may also provide feedback. The other peers 33 may be either offline peers or online, as described by the quality control measures 26. Feedback stickers 30, receipts, or APIs may be used to display or communicate data 12. Analytics provided via a dashboard used by feedback receivers 10 may reveal metrics on how to avoid pitfalls and increase value and customer retention.

Users are given at least three options to enroll or sign-up to submit feedback. A first option allows users to enroll as feedback receivers 10, feedback submitters 16, or both. A second option allows them to specify their role in using he platform and to provide personal information and to enroll using social media APIs embedded in popular social networking platforms. A third option provides for a feedback receiver 10 to create a simple profile, post a basic one-question (or more) feedback project, and locate feedback submitters who are relevant to the feedback project.

The data 12 may be processed using programming code comprising at least one of php, html, and java which may include various algorithms that execute the activities done by both feedback receivers 10 and submitters 16 using a web platform connected to the internet. Feedback data 12 is converted to analytical, textual and numerical formats, which provide visual and statistical indication and remedies (corrective steps and suggestions) for a business (the feedback receiver 10) to improve. With the end data 12, feedback receivers 10 may be able to develop sustainable improvements for their businesses.

Feedback receivers 10 receive actionable feedback data 12 based on the aggregate data from feedback submitters 16 run by internet programming languages which identifies and displays data 12 via the feedback receiver dashboards in order to improve a business. The feedback response data 12 contains the steps and recommendations for improvement. The data 12 may be exported to share and distribute corrective actions to peers and teams of the business practitioner (the feedback receiver 10). Feedback data 12 may be exported on point-of sale receipts or customized as a decal sticker allowing the business to print and display an active feedback project and obtain instant feedback to test new products and services with store, venue, or event guests and customers.

Composite methods are provided herein to collect business feedback faster through a specific reversible process that requires the usage of internet/web programming/code. The reversibility of the process allows not only the business to collect feedback but send feedback as well. The process is a reward-for-feedback reversible loop which can be used in web application and eventually in a future mobile application form as well.

In an example, a regional bus line that operates in an area comprising several states may wish to expand its routes while increasing ridership on its existing routes. Management of the bus line may be considering fare changes or schedule adjustments and want customer input before implementing such changes.

The bus company operator may begin by enrolling in the system using one of the three methods described above. A profile of the operator (the feedback receiver 10 in this example) is created. The operator creates a customized project based on problems the operator has observed with the company's route network, fare structure, or other aspects of its business with which riders have contact.

The operator adds details and instructions for feedback submitters 16, i.e. riders, to consult when responding to surveys. The operator also selects if he/she is seeking public or private feedback and selects one of anonymous or non-anonymous feedback. The operator might also add a video clip of a problem area such as a route map or fare chart and notes when a survey period expires.

The bus company operator, the feedback receiver 10 in this use case, may construct a survey with as many polls, ratings and questions as possible to solicit meaningful feedback from riders. Sample questions might ask, “Would a different fare structure on weekends encourage you to ride with us more often?” or “What cities or towns that are presently not served or underserved would you like to see added to our routes?” The operator might also create customized rewards for various classes of riders.

The bus company operator may create a demographic profile that targets specific feedback submitters 16 and may add in experience-based requirements for feedback submitters 16 and enter in promotional codes for those submitters 16 to receive incentives. Once the project is posted, the operator is presented with a feedback submitter screen which allows the operator to search for feedback submitters based on one or more options. Such options include industry, occupation, location, skills, interests, username, gender, age range, and proximity to bus depots or cities served by the bus company. Feedback submitters 16 can also be located and specifically chosen by the bus company operator via a feedback submitter map provided herein.

Once a feedback submitter 16 is located, a feedback submitter information card will display a match percentage. If the feedback submitter 16 described in the card meets requirements set by the bus company operator and the details of the project, the submitter 16 is sent an invitation to respond and submit feedback. After the submitter views the invitation that may be received via email, the submitter 16 may begin submitting feedback on the project.

While the project is ongoing, the bus company operator may receive various surveys submitted by invited and non-invited feedback submitters 16. The operator may extend the project past the expiration date initially set. The operator may print feedback stickers 30 to notify riders of an online feedback project and offer incentives for riders to go online or on the phone to join in and receive incentives such as discounts on future trips or a chance to win free trips.

The operator may use a live-feedback option as a tool to solicit live feedback, votes and other insight during events held in cities served by the bus line. The feedback received by the operator may be text, recorded voice, and even video. The feedback may be analytical, graphical, and/or numeric.

The operator may, as a feedback receiver 10 and project creator, be allowed to joint online networks to which some of the bus line's riders may belong. The operator may share some feedback with riders on the network in an effort to encourage further feedback from riders. The operator would of course protect the confidentiality of feedback receivers 16 whose feedback the operator shares on the network.

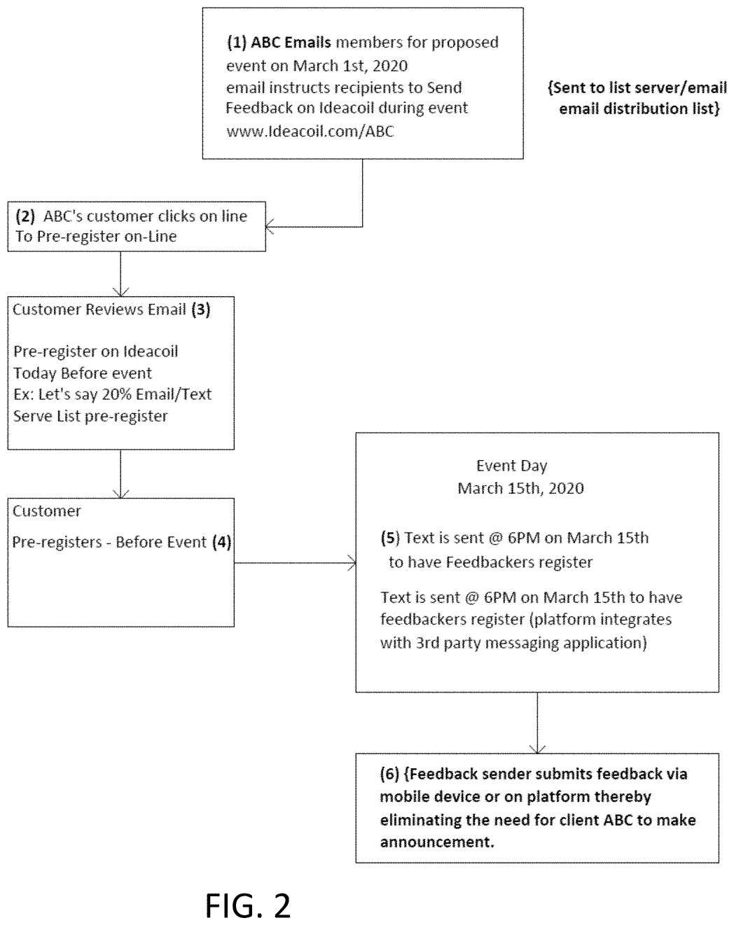

FIG. 2 is a flow chart of a method of feedback through an online community format according to an embodiment of the present disclosure. FIG. 2 illustrates a process flow of pre-registration for feedback submitters. The purpose of pre-registration is to allow feedback submitters to pre-register before attending an event. In the scenario depicted in FIG. 2, a client is ABC and is the business sending feedback from its customers (members) during a proposed event.

Beginning at (1), ABC emails members for a proposed event on Mar. 1, 2020. The email instructs recipients to send feedback on Ideacoil during the event. The emails are sent to list server/email distribution list. At (2), ABC's customer clicks online to pre-register and at (3) the customer reviews the email. At (4), the customer pre-registers. At (5), at text message is sent on event day, Mar. 15, 2020, to have feedbackers register. At (6), the feedback sender submits feedback via mobile device or on platform thereby eliminating the need for client ABC to make an announcement.

In embodiments, systems and methods provide for a strategy agility index to be calculated that measures changes in newly surveyed data points compared to the same data points captured in previous surveys. Such previously captured survey results may be subjected to a benchmarking feature of the application described above to establish a standard or baseline for further surveys. Questions in previous surveys used to generate the benchmarked data are then updated and used in a new survey to the same or substantially similar feedback submitters 16 who participated in the previous surveys.

Results of the new survey, whose questions have been updated, are compared with the benchmarked data generated from earlier surveys which were based on non-updated questions. The comparisons are used to generate a strategy agility index which describes changes in the user's business. Since the questions in the both the previous and new surveys are directed to key drivers in the business of the feedback receivers 10 such as customer satisfaction, the strategy agility index may provide insight into how a feedback receiver 10 is performing in its business and suggest changes the feedback receiver 10 may implement toward improvement.

The strategy agility index is a comparison score based on newly aggregated data collected on key business performance metrics such as customer retention, sales, customer satisfaction, and service quality in relation to previously gathered data (the benchmarked data) on the same categories. Based on the calculated agility index, a feedback receiver 10 may better understand its needs to fortify, downsize, or maintain consistent in its operations to become more efficient and achieve profitability as well as meet and exceed customer satisfaction and retention objectives.

Steps toward calculating the strategy agility index may be as follows:
1) A feedback receiver creates a project on the platform. The project consists of a questionnaire pertaining to key business drivers such as customer service, customer satisfaction, and customer complaints filed. Such questions can consist of survey questionnaires such as polls for voting, numeric, and text-based rankings and ratings, and open-ended questions.
2) Feedback submitters 16 submit their completed questionnaires.
3) Feedback data is processed by the application, aggregated, and is stored on application for the feedback receiver 10 to access.
4) The feedback receiver 10 benchmarks the received questionnaire results by activating a benchmark feature on the application.
5) The feedback receiver 10 edits and updates the questionnaire and sends out the questionnaire in a new survey.
7) New survey results based on the edited and updated questionnaire are compared to the benchmarked data. Text based responses are processed by an artificial intelligence filtering system and are analyzed for similarities with previously received text-based feedback data.
8) The application determines percentage changes (increase or decrease) in newly received survey results over the benchmarked data.
9) The application uses the comparison data to assign an agility index for each question item in the edited and updated questionnaire. This step applies to both numeric survey data and text-based survey feedback data.

The chart below provides an example of calculations of the strategy agility index.

| | | New | | |
|---|---|---|---|---|
| | Original | Benchmarked | | |
| | Feedback | Feedback | | |
| Previous Data | Data | Data | | |
| Collected on | Cumulative | Cumulative | New Data/ | |
| application/ | Average | Average | Existing | Agility |
| Invention | Data | Data | Data | Index |
| Customer Retention | 6/10 | 7/10 | 70%/60% | 1.16 |
| Customer | 7/10 | 7/10 | 70%/70% | 1.0 |
| Satisfaction | | | | |
| Service Quality | 4/10 | 7/10 | 70%/40% | 1.75 |
| Text-input for | 400 | 200 | 400/200 | 2.0 |
| complaint issues ⁽¹⁾ | | | | |

In the chart, an agility index of 1.16 for the Customer Retention and 1.75 for Service quality are indications that the feedback receiver 10 may have improved in those fields and therefore has the potential to increase profitability. For text-based feedback, an algorithm in the application may determine the frequency at which customer complaint words are mentioned in the feedback data.

The strategic agility index may leverage the use of the platform/application for businesses to grow strategically and remain aligned with customer feedback. The agility index may promote businesses to develop a break-through marketing presence, and ultimately decrease the likelihood of failure. Business agility is about balancing effective feedback and constantly making improvements. The strategic agility index is a critical tool designed to help businesses learn and navigate customer-driven markets in areas of their businesses as sales/growth, customer/product/service quality, and customer retention.

The index may also measure the likelihood for a business to be successful for a particular deliverable item, and signal a direction or action which the business should be investing in.

The index may help minimize risk and pinpoint parameters critical to success of a business strategy. Utilizing interventions across all quadrants create an environment in which a business is likely to change how it thinks and behave, which therefore, inspire customers to be fully invested in the growth of a business and a direct contributing mechanism to help any business entity yield higher profit margins.

What is claimed is:

1. A system for generating an agility index associated with product survey results, comprising:
a processor;
a memory; and
an application stored in the memory that when executed on the processor:
receives, aggregates and stores a first survey feedback data received in a first survey,
activates a feature to benchmark the first survey data,
edits and updates survey questions to produce a second questionnaire,
distributes the second questionnaire in a second survey, and
compares a second survey feedback received in the second survey to the benchmarked first survey data to determine a strategic agility index.

2. The system of claim 1, wherein the comparison comprises determining percentage changes in surveyed data points from the first survey to the second survey.

3. The system of claim 1, wherein the second survey is sent to one of the same and similar feedback submitters that submitted the first survey feedback data.

4. The system of claim 1, wherein the first and second surveys are directed to sales growth, product and service quality, and customer retention.

5. The system of claim 1, wherein survey questionnaires include numeric and text questions.

6. The system of claim 1, wherein feedback submitters for the surveys are described in profiles created around products and services of interest to the submitters.

7. The system of claim 1, wherein feedback submitters who consistently furnish survey feedback meeting a predetermined quality level are provided incentives to continue doing so.

8. A method of determining strategic agility based on benchmarking of survey feedback, comprising:
a computer receiving a first survey feedback through an online community, the feedback related to at least one product;
the computer refining the first feedback to remove frivolous content and yield a quality of feedback meeting a predetermined standard;
the computer benchmarking survey data contained in the refined first feedback;
the computer conducting a second survey with questions updated from previous surveys, the previous surveys having yielded at least the first feedback;
based on a second feedback generated from the second survey, the computer calculating an agility index.

9. The method of claim 8, further comprising the computer comparing the second feedback with the refined first feedback to calculate the agility index.

10. The method of claim 9, further comprising the computer determining percentage changes of surveyed data points from the refined first feedback to the second feedback to calculate the agility index.

11. The method of claim 8, wherein the online community comprises parties having previously expressed interest in the at least one product.

12. The method of claim 8, further comprising wherein surveys are directed to sales growth, product and service quality, and customer retention.

13. The system of claim 8, wherein the surveys are directed to inducing customers to recommend improvements to the at least one product.

14. The system of claim 8, wherein the feedback is received via at least one of electronic mail, hard copy, and live streaming.

15. A system for producing a strategic agility index, comprising:
a computer and an application executing thereon that:
searches a database for at least one demographic profile describing previous survey feedback providers for a first product,
benchmarks survey feedback previously received from the providers,
distributes a new survey with questions updated from previous surveys,
generates an agility index based on results of the new survey over the previous surveys.

16. The system of claim 15, wherein the computer determines percentage changes of surveyed data points from the previous surveys to the new survey to generate the agility index.

17. The system of claim 15, wherein the new survey is sent to parties described by the profile and qualified as providing feedback meeting quality requirements.

18. The system of claim 17, wherein the computer customizes rewards and incentives designed to elicit continuing survey feedback meeting the requirements.

19. The system of claim 18, wherein the computer delivers the rewards and incentives to feedback providers identified as consistently providing feedback meeting the requirements.

20. The system of claim 15, wherein the surveys are directed to sales growth, product and service quality, and customer retention associated with the first product.
